(19) United States
(12) Patent Application Publication
(10) Pub. No.: US 2002/0012124 A1
(43) Pub. Date: Jan. 31, 2002

(54) Apparatus and methods for measuring surface profiles and wavefront aberrations, and lens systems comprising same

(75) Inventors: Shigeru Nakayama, Kawasaki-shi (JP); Yuichi Takigawa, Kawasaki-shi (JP); Takashi Gemma, Tokyo (JP)

Correspondence Address: KLARQUIST SPARKMAN CAMPBELL, LEIGH & WHINSTON, LLP, One World Trade Center, 121 S.W. Salmon Street, Suite 1600, Portland, OR, 97204, US

(73) Assignee: Nikon Corporation

(21) Appl. No.: 09/828,301

(22) Filed: Apr. 6, 2001

(30) Foreign Application Priority Data
Apr. 6, 2000 (JP) 2000-105156
Mar. 21, 2001 (JP) 2001-079695

(51) Int. Cl. G01B 9/02

(52) U.S. Cl. 356/489; 356/512; 356/515

(57) ABSTRACT

Apparatus and methods are disclosed for measuring a surface profile and/or a wavefront aberration of a target object. Exemplary target objects include mirrors, lenses, and lens systems. A representative apparatus configuration includes a light source, a light-flux optical system, a phase-state changing device, a detector, and a computer. The light-flux optical system (i) produces, from a light flux produced by the light source, measurement-light and reference-light fluxes, (ii) directs the measurement-light flux to the target object, (iii) provides the reference-light flux with a standard wavefront, and (iv) establishes interference between the two light fluxes. The phase-state changing device changes a phase state of the reference-light flux and/or the measurement-light flux relative to a respective standard. The detector detects interference fringes. The computer produces, from the detected interference fringes produced at different respective phase states, data concerning respective phase distributions, and calculates an average phase distribution. The average phase distribution, obtained using data from multiple phase states, substantially reduces the effects of reflected-light noise.

### FIELD OF THE INVENTION

This invention pertains to apparatus and methods for measuring a surface profile of an object such as a lens, mirror, or other optical element. The invention also pertains to apparatus and methods for measuring aberrations of a wavefront propagating from an object such as a projection lens or the like.

### BACKGROUND OF THE INVENTION

The recent demand for higher-precision optical devices has led to a progressive increase in the accuracy and precision with which lenses, mirrors, and other optical elements are manufactured. Accordingly, greater accuracy and precision is required in apparatus and methods for measuring the surface profile of optical elements.

With an extremely high-accuracy lens system such as a projection lens for a stepper machine, wavefront aberrations of the lens system are measured at various stages during assembly of the lens system, and adjustments are made to the system based on the data obtained during such measurements. It will be appreciated immediately that extremely high accuracy and precision are required in the apparatus used for measuring wavefront aberrations.

Conventionally, Fizeau interferometers and the like are employed for measuring surface profiles and wavefront aberrations of optical elements. Unfortunately, reflected-light noise from the optical components of these interferometers, including lenses associated with these interferometers, has become a more significant problem as measurement accuracy has increased. Designers of optical systems normally take care to minimize the effects of reflected-light noise on their measurements. A common technique is to employ a suitable anti-reflective coating applied to at least some of the optical components.

In the optical design of a conventional apparatus for measuring surface profiles, it is extremely difficult to account for all multipath-reflected light that may occur in an optical system. Furthermore, the degree to which reflections are reduced by using an anti-reflective coating is inadequate for interference measurements of extremely high accuracy.

Also, because light rays propagating near an optical axis are incident at nearly right angles on most optical surfaces such as lenses, it heretofore has been very difficult to avoid reflected-light noise.

### SUMMARY OF THE INVENTION

In view of the shortcomings of conventional apparatus and methods as summarized above, an object of the invention is to provide improved apparatus and methods for measuring a surface profile (shape) of an object (e.g., lens, mirror, or other optical component) with high accuracy. Another object is to provide improved apparatus and methods for measuring certain optical characteristics such as wavefront aberrations of light propagating from an object such as a lens or mirror.

To such ends, and according to a first aspect of the invention, apparatus are provided for measuring a surface profile of a target surface. An embodiment of such an apparatus comprises a light source, a light-flux optical system, a phase-state changing device, a detector, and a computer. The light source produces a light flux. The light-flux optical system performs several functions. First, it produces from the light flux a measurement-light flux and a reference-light flux. Second, it directs the measurement-light flux to the target surface so as to reflect from the target surface. Third, it provides the reference-light flux with a standard wavefront. Fourth, it establishes an interference between the reference-light flux and the measurement-light flux reflected from the target surface. The phase-state changing device is configured to change a phase state of the reference-light flux and/or the measurement-light flux relative to a standard. The detector is configured to detect interference fringes produced by the interference at any of the various phase states. The computer is connected to the detector and to the phase-state changing device, and is configured to produce, from the detected interference fringes produced at different respective phase states, data concerning respective phase distributions, and to calculate an average phase distribution.

The phase-state changing device can be configured to change the phase state of the reference-light flux or the phase state of the measurement-light flux. Alternatively, the phase-state changing device can be configured to change the phase state of both the reference-light flux and the measurement-light flux a same amount relative to the standard, while maintaining a constant phase difference between the reference-light flux and the measurement-light flux.

The phase-state changing device can be configured to change the phase state in respective increments, relative to the standard, of 0, π/2, π, and 3π/2. Alternatively, the phase-state changing device can be configured to change the phase state in respective increments, relative to the standard, of 0, π/4, π/2, π/4, π, 5π/4, 3π/2, and 7π/4. Further alternatively, the phase-state changing device can be configured to change the phase state in respective irregular increments, relative to the standard, of from 0 to 2π, and more than 2π as a whole.

This apparatus embodiment can include a phase-modulation device situated and configured to produce a phase modulation of the measurement-light flux or of the reference-light flux.

The measurement-light flux can have a frequency that is slightly different than a frequency of the reference-light flux. In such a configuration, the interference is heterodyne interference. In this configuration, the reference-light flux and measurement-light flux can have mutually perpendicular polarization planes.

According to another aspect of the invention, apparatus are provided for measuring a wavefront aberration of a target object. An embodiment of such an apparatus comprises a light source, a light-flux optical system, a phase-state changing device, a detector, and a computer. The light source produces a light flux. The light-flux optical system is configured to perform several functions. First, it produces from the light flux a measurement-light flux and a reference-light flux. Second, it directs the measurement-light flux to the target object so as to be transmitted through the target object. Third, it provides the reference-light flux with a standard wavefront. Fourth, it establishes an interference between the reference-light flux and the measurement-light flux transmitted by the target object. The phase-state changing device is configured to change a phase state of the referencelight flux and/or the measurement-light flux relative to a standard. The detector is configured to detect interference fringes produced by the interference at any of the various phase states. The computer is connected to the detector and the phase-state changing device, and is configured to produce, from the detected interference fringes produced at different respective phase states, data concerning respective phase distributions, and to calculate an average phase distribution. As summarized above, the phase-state changing device can be configured to change the phase state of the reference-light flux, the measurement-light flux, or both the reference-light flux and the measurement-light flux. In the latter instance, a constant phase difference between the reference-light flux and the measurement-light flux is maintained. In addition, the phase-state changing device can be configured to change the phase state in respective increments, relative to the standard, of 0, π/2, π, and 3π/2. Alternatively, the phase-state changing device can be configured to change the phase state in respective increments, relative to the standard, of 0, π/4, π/2, 3π/4, π/5π/4, 3π/2, and 7π/4. Further alternatively, the phase-state changing device is configured to change the phase state in respective irregular increments, relative to the standard, of from 0 to 2π, and more than 2π as a whole.

This embodiment can include a phase-modulation device situated and configured to produce a phase modulation of the measurement-light flux and/or the reference-light flux. In addition, the measurement-light flux has can have a frequency that is slightly different than the frequency of the reference-light flux, so as to produce heterodyne interference.

According to another aspect of the invention, methods are provided for measuring a surface profile of a target surface of an object. In an embodiment of such a method, a measurement-light flux is directed to the target surface so as to cause the measurement-light flux to reflect from the target surface. A reference-light flux is provided having a standard wavefront produced by reflection from a standard surface. A mutual interference is established between the reference-light flux and the measurement-light flux, and a respective phase-difference interference pattern produced by the interference is detected. At least one of the target surface and the standard surface (i.e., the target surface and/or the standard surface) is moved a respective specified distance from a respective standard position, then the preceding steps are repeated. The respective specified distance is appropriate to change a phase state of the at least one of the light fluxes a specified amount. The at least one of the target surface and standard surface is moved again a respective distance, and the preceding steps are repeated to obtain respective phase-difference interference patterns at multiple phase states. From the respective phase-difference interference patterns that are obtained, an average phase-difference distribution of the target surface is determined.

As summarized above, only the standard surface can be moved, only the target surface can be moved, or both the standard surface and target surface can be moved. In the latter instance, a constant phase difference between the reference-light flux and the measurement-light flux is maintained despite the movement. If only the standard surface or target surface is moved, then the step of detecting a phase-difference interference pattern can be performed by phase-shift interference involving phase modulation of the measurement-light flux or reference-light flux, respectively. Furthermore, movement(s) of the target surface and/or the standard surface can be made so as to change the phase state in a respective increment, relative to the standard, of 0, π/2, π, and 3π/2, and then to 2π. Alternatively, the movement(s) can be made so as to change the phase state in a respective increment, relative to the standard, of 0, π/4, π/2, 3π/4, π, 5π/4, 3π/2, and 7π/4, and then to 2π. Further alternatively, the movement(s) can be made so as to change the phase state by irregular increments, relative to the standard, of from 0 to 2π, and more than 2π as a whole.

The measurement-light flux can be provided with a frequency that is slightly different than a frequency of the reference-light flux so as to establish a heterodyne interference between the reference-light flux and the measurement-light flux.

The object that is the subject of the method summarized above can be an optical element including a target surface having a surface profile measured using the method.

According to another aspect of the invention, methods are provided for measuring a wavefront aberration of a target object. In an embodiment of such a method, a measurement-light flux is directed to the target object so as to cause the measurement-light flux to be transmitted in a first direction through the target object to a reflection member (e.g., mirror). The measurement-light flux transmitted in the first direction through the target object is reflected so as to cause the measurement-light flux to return through the target object in a second direction. A reference-light flux is provided having a standard wavefront produced by reflection from a standard surface. A mutual interference is established between the reference-light flux and the returning measurement-light flux, and a respective phase-difference interference pattern produced by the interference is detected. After performing the foregoing steps, at least one of the reflection member and the standard surface (i.e., the reflection member, the standard surface, or both) is moved a respective specified distance from a respective phase-standard position, wherein the respective specified distance is appropriate to change a phase state of the respective light flux(es) a specified amount. Then, the foregoing steps are repeated to obtain respective phase-difference interference patterns at the multiple phase states. An average phase-difference distribution of the target object is determined from the respective phase-difference interference patterns obtained at the multiple phase states.

Desirably, a mirror is provided downstream of the target object to reflect the measurement light flux. Hence, motion of the target object is accompanied by corresponding movement of the mirror. If both the target object (with mirror) and the standard surface are moved, a constant phase difference between the reference-light flux and the measurement-light flux desirably is maintained.

Either the reference-light flux or measurement-light flux can be modulated, in which instance the detected interference is a phase-shift interference. In addition, the measurement-light flux can be provided with a frequency that is slightly different than a frequency of the reference-light flux. Under such conditions, a heterodyne interference is established between the reference-light flux and the measurement-light flux.

The incremental movements of the reflection member and/or standard surface for the purpose of changing phase states can be as summarized above.

The target object can be a lens element. Hence, another aspect of the invention pertains to lens elements of which the wavefront aberration has been measured using a method according to the invention. The lens elements can comprise a lens system such as a projection lens.

According to another aspect of the invention, apparatus are provided for measuring an optical characteristic of a target object. An embodiment of such an apparatus comprises a light source, a light detector, an optical system, an actuator, a phase-detection device, and a computer. The light source produces a light flux. The optical system is situated relative to the light source and the target object and is configured to perform multiple tasks. First, it produces from the light flux a measurement-light flux and a reference-light flux. Second, it directs the measurement-light flux to the target object so as to reflect from the target surface. Third, it provides the reference-light flux with a standard wavefront. Fourth, it establishes an interference between the reference-light flux and the measurement-light flux from the target object. Fifth, it directs the interfering reference-light flux and measurement-light flux to the detector. The actuator is situated and configured to move the target object and/or the standard surface a respective specified distance relative to a respective standard location. The phase-detection device is connected to the detector. The phase-detection device is configured to detect respective phase differences in the detected light, at the various locations resulting from movement (by the actuator), of the target object and/or standard surface over the respective specified distance. The computer is configured to determine respective phase distributions from the respective phase differences and to calculate, from the respective phase distributions, an average phase distribution. The average phase distribution corresponds to a measurement of the optical characteristic.

The optical characteristic can be, for example, a surface profile of the target object or a wavefront aberration of the target object.

The actuator can be configured to move the standard surface relative to the respective standard location. Alternatively, the actuator can be configured to move the target object relative to the respective standard location. In the latter configuration, the apparatus can include a reflection member situated relative to the target object such that measurement light transmitted in a first direction through the target object reflects from the reflection member and returns via a second direction, opposite the first direction, through the target object. The returning measurement light interferes with the reference-light flux. Also, in this configuration, the actuator desirably is configured to move both the target object and the reflection member while maintaining a constant distance between the target object and the reflection member.

Further alternatively, the actuator can be configured to move both the standard surface and the target object relative to the respective standard locations. In such a configuration, the movements are made while maintaining a constant phase difference in the interfering reference-light flux and measurement-light flux. This configuration desirably also comprises a reflection member situated relative to the target object such that measurement light transmitted in a first direction through the target object reflects from the reflection member and returns via a second direction, opposite the first direction, through the target object to interfere with the reference-light flux. In this configuration, the actuator is configured to move both the target object and the reflection member while maintaining a constant distance between the target object and the reflection member.

The target object can be, for example, a lens element. With respect to a lens element, the optical characteristic can be a wavefront aberration measured using the apparatus summarized above. The lens element can be embodied as a projection lens system.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic optical diagram of a surface-profile-measurement apparatus according to a first representative embodiment.

FIG. 2 is a flow chart of a procedure for performing a surface-profile measurement according to the first representative embodiment.

FIG. 3 is a vector diagram of the complex amplitude of the measurement-light flux and the complex amplitude of the reference-light flux, as plotted on a complex plane and as described in the first representative embodiment.

FIG. 4 is a schematic optical diagram of a surface-profile-measurement apparatus according to a second representative embodiment.

FIG. 5 is a schematic optical diagram of a surface-profile-measurement apparatus according to a third representative embodiment.

FIG. 6 is a schematic optical diagram of a surface-profile-measurement apparatus according to a fourth representative embodiment.

FIG. 7 is a schematic optical diagram of a surface-profile-measurement apparatus according to a fifth representative embodiment.

FIG. 8 is a schematic optical diagram of a wavefront-aberration-measurement apparatus according to a sixth representative embodiment.

FIG. 9 is a flow chart of a procedure for obtaining wavefront-aberration measurements using the apparatus of the sixth representative embodiment.

### DETAILED DESCRIPTION

The invention is described below in the context of representative embodiments that are not intended to be limiting in any way.

First Representative Embodiment

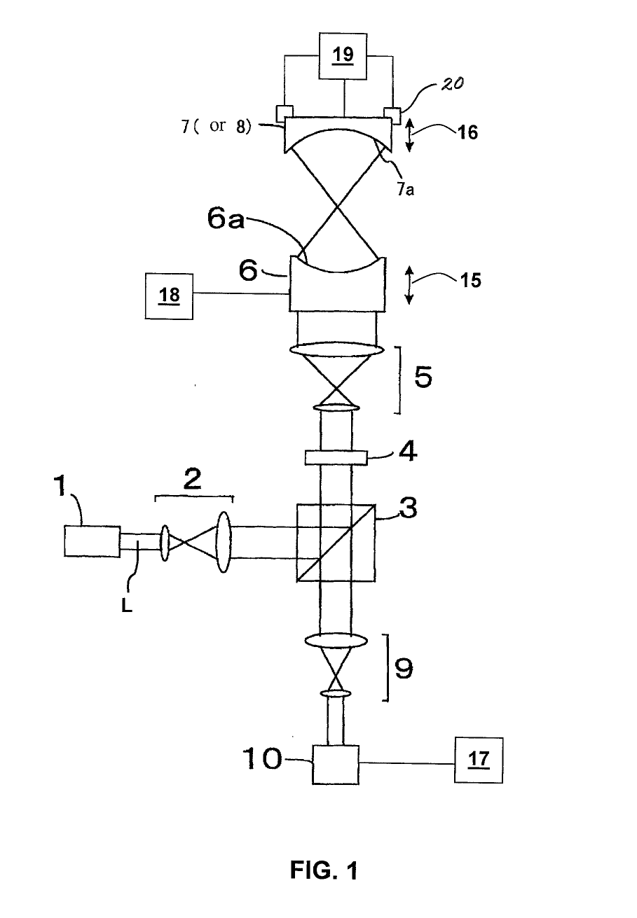

A surface-profile-measurement apparatus according to this embodiment is shown in FIG. 1. A beam L of laser light is produced by a laser light source 1. The beam passes through a first beam-expander 2 to a polarizing beamsplitter (PBS) 3. (As used herein, a “beam-expander” simply increases the diameter or transverse dimension of a beam of light.) Light reflected from the PBS 3 passes through a λ/4 retarder 4, a second beam-expander 5, and a Fizeau lens 6 to a target object 7 (or standard prototype 8). Light reflected from the target object 7 returns through the Fizeau lens 6, the second beam-expander 5, and the λ/4 retarder 4 to the PBS 3. Light passing through the PBS 3 passes through a beam-reducer 9 to a two-dimensional image detector 10 (e.g., photodiode or CCD array). (As used herein, a “beam-reducer” simply decreases the diameter or transverse dimension of a beam of light.)

The light beam L emitted by the laser light source 1 is linearly polarized. The first beam-expander 2 increases the beam diameter of linearly polarized light L emitted from the laser light source 1 for incidence on the PBS 3. The polarization plane of the light L is selected so that the PBS 3 reflects the incident light toward the target object 7. Similarly, the second beam-expander 5 increases the beam diameter of light propagating toward the target object 7 and decreases the beam diameter of light returning from the target object 7.

The Fizeau lens 6 includes a Fizeau surface 6a. The Fizeau surface 6a functions as a reference surface, and light reflected from the Fizeau surface 6a serves as a reference-light flux. This reference-light flux returns through the PBS 3 via the second beam-expander 5 and the λ/4 retarder 4. The beam diameter of the reference-light flux is reduced by passage through the beam-reducer 9, after which the reference-light flux is incident on the two-dimensional image detector 10.

Meanwhile, light transmitted by the Fizeau surface 6a is used as a measurement-light flux. This measurement-light flux is reflected by a target surface 7a of the target (test) object 7. Light reflected from the target surface 7a returns to the PBS 3 via the Fizeau lens 6, the second beam-expander 5, and the λ/4 retarder 4. The beam diameter of the measurement-light flux transmitted by the PBS 3 is reduced by passage of the beam through the beam-reducer 9, after which the measurement-light flux is incident on the two-dimensional image detector 10.

The two-dimensional image detector 10 detects interference fringes produced by interference of the reference-light flux and the measurement-light flux. To reach the image detector 10, polarized light reflected by the PBS 3 passes through the λ/4 retarder 4 twice, a first time while propagating toward the target object 7 and a second time returning from the target object 7. (The optical path toward the target object 7 is termed the “forward path” and the optical path away from the target object 7 is termed the “reverse path.”) As a result of the two passages through the λ/4 retarder 4, the polarization plane of the light is rotated 90 degrees, which allows the light on the reverse path to be transmitted by the PBS 3.

The beam-reducer 9 also serves to form an image of the target surface 7a on the image detector 10. The beam-reducer 9 is configured for reduced distortion so that the profile (shape) of the target surface 7a can be ascertained accurately even whenever the target surface 7a is aspherical, for example. Coordinates on the target surface 7a can be correlated accurately to coordinates on the two-dimensional image detector 10 by using the distortion specification in the design of the second beam-expander 5 and beam-reducer 9 or a measured distortion to correct the lateral coordinates of the interference fringes.

An adjustment mechanism 18 is provided for adjusting the axial position (arrow 15) of the Fizeau lens 6 relative to the target surface 7a or to a standard prototype 8. The adjustment mechanism 18 can be used to produce stepped changes of phase in the reference-light flux with respect to a standard.

The data output by the image detector 10 is input to a computer 17 for data analysis. From such data, the phase distribution of the detected interference fringes is calculated by the computer 17 using an appropriate algorithm.

At each phase step, the phase distribution of the interference fringes (i.e., the phase at various points of the target surface 7a) can be determined with high accuracy using the known “phase-shift interference” method. In the phase-shift interference method, the target object 7 is moved (note arrow 16) by an actuator 19 so as to move the target surface 7a “minutely” (within the range of 0 to 2π) in the optical-axis direction. To achieve this movement, the actuator 19 can include a piezoelectric element that engages a target-object holder 20. Herein this method is referred to as “phase-shift interference,” which features phase modulation of the measurement-light flux.

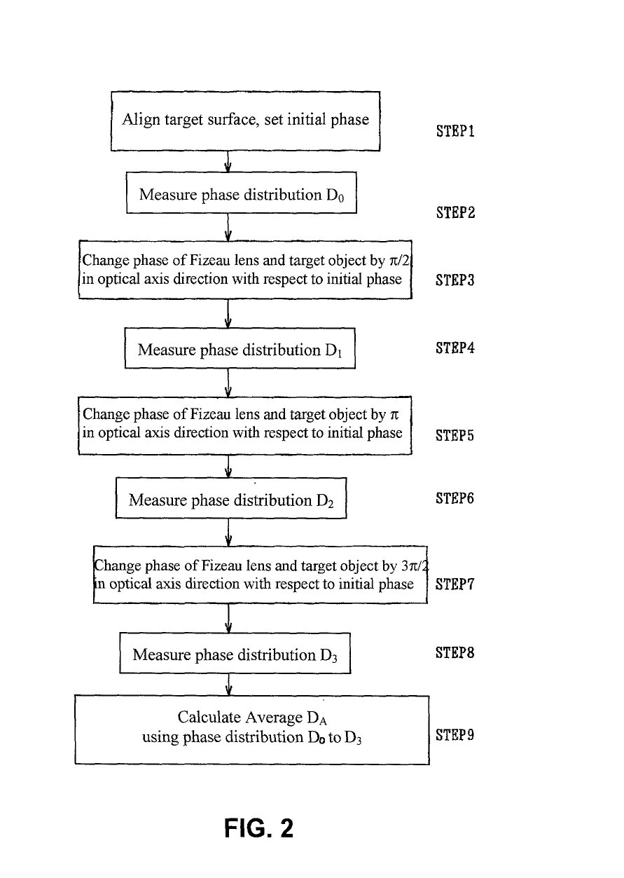

A procedure for performing a surface-profile measurement, according to this embodiment, of a target surface 7a and for processing the measurement data is outlined in FIG. 2. FIG. 2 essentially depicts a flow chart of the procedure.

First, a phase distribution of the target surface 7a is measured at an initial phase state. The target object 7 is mounted in the target-object holder 20. The target object 7 is aligned so that interference fringes produced by the target surface 7a are as coarse as possible (Step 1). This initial phase state is termed the “standard” of the reference-light flux and the measurement-light flux. In this initial phase state, the phase distribution (i.e., distribution of phase at various points on the target surface) D₀ is measured for the target surface using the phase-shift-interference method described above (Step 2).

Next, both the Fizeau lens and the target object are displaced (“phase stepped”) in the optical-axis direction by a distance equivalent to π/2 of the standard (Step 3). At this displacement, the phase distribution of the interference fringes is in substantially the same phase state as the initial phase state. Using the phase-shift-interference method discussed above, the phase distribution (i.e., distribution of phase at various points on the target surface) D₁ is measured (Step 4).

Further phase stepping (at increments of π/2) with respect to the standard is performed. At each phase step, measurements are obtained (in the same manner as summarized above) of the respective phase distributions of the interference fringes to obtain the respective phase distributions D₂ and D₃ (steps 5, 6, 7, and 8).

The phase distributions D₀, D₁, D₂, D₃ obtained in the foregoing measurements are averaged in a calculation of an average phase distribution D_{A}, representing the phase distribution of the interference fringes generated by interference between the measurement-light flux and the reference-light flux (Step 9). The average phase distribution D_{A} can be input to the computer, which applies an algorithm for calculating shape error, based on the average phase distribution D_{A}.

The reason for averaging multiple phase distributions in this process is to reduce the effect of noise light. The principle of reducing the effect of noise light is discussed later below.

After performing the foregoing procedure to determine an average phase distribution D_{A} of the target surface, the same procedure is used to determine an average phase distribution of the standard prototype 8. The only difference is that the standard prototype 8 is mounted in the holder in place of the target object. Thus, the phase distributions of interference fringes produced by the standard prototype are measured. An average phase distribution of the standard prototype is determined as described above. Phase differences are calculated, using the average phase distributions of the target surface 7a and of the standard prototype 8, at various corresponding points on the target surface versus the standard prototype. These phase differences are calculated readily by the computer 17 using an appropriate algorithm.

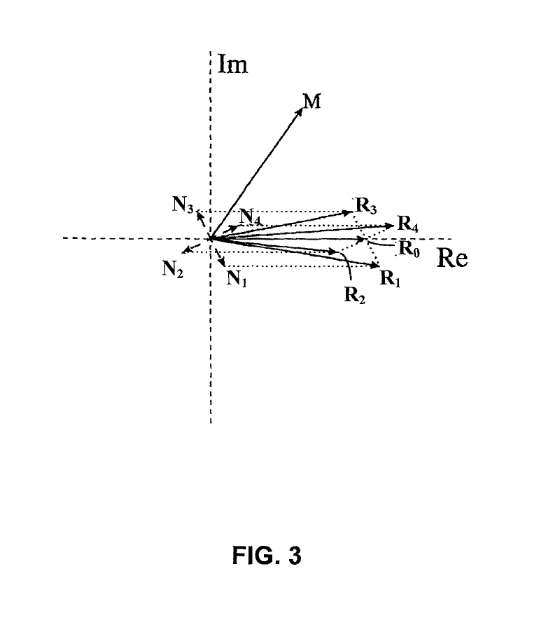

The principle of reducing the effects of noise light using the surface-profile measurement apparatus according to this embodiment now is described with reference to FIG. 3. In FIG. 3, the complex amplitude of the measurement-light flux and the complex amplitude of the reference-light flux are plotted on a complex plane. Here, Re is the real portion of the complex amplitude, and Im is the imaginary portion. Reflected noise light is assumed to be generated from the lenses constituting the second beam-expander 5. M is the complex amplitude of the measurement-light flux, and R₀ is the complex amplitude of the reference-light flux with no noise light. The angle formed by the complex amplitude M of the measurement-light flux and the complex amplitude R₀ of the reference-light flux corresponds to the phase.

When using the phase-shift-interference method described above, in which the phase of the measurement-light flux is modulated, the noise light is added to the reference-light flux. Hence, stepping the phase of the reference-light flux in the manner “0” (initial phase)→π/2→π→3π/2 allows the phase of the noise light to be considered as being stepped from “0” (producing amplitude N₁ in FIG. 3)→−π/2 (producing amplitude N₂ in FIG. 3)→−π (producing amplitude N₃ in FIG. 3)→−3π/2 (producing amplitude N₄ in FIG. 3) with respect to the reference-light flux. Respective vector sums R₁ to R₄ of amplitude of the reference-light flux are obtained by adding the respective complex amplitudes N₁ to N₄ of the noise-light flux to the complex amplitude R₀ of the reference-light flux.

At each phase step, the phase difference between the measurement-light flux M and the respective reference-light flux R₁ to R₄ is calculated by the phase-shift interference method. The effect of noise light is reduced by averaging the measured phase differences, and a phase difference roughly equal to the phase difference between the measurement-light flux M and the reference-light flux Ro is determined by the averaging.

Second Representative Embodiment

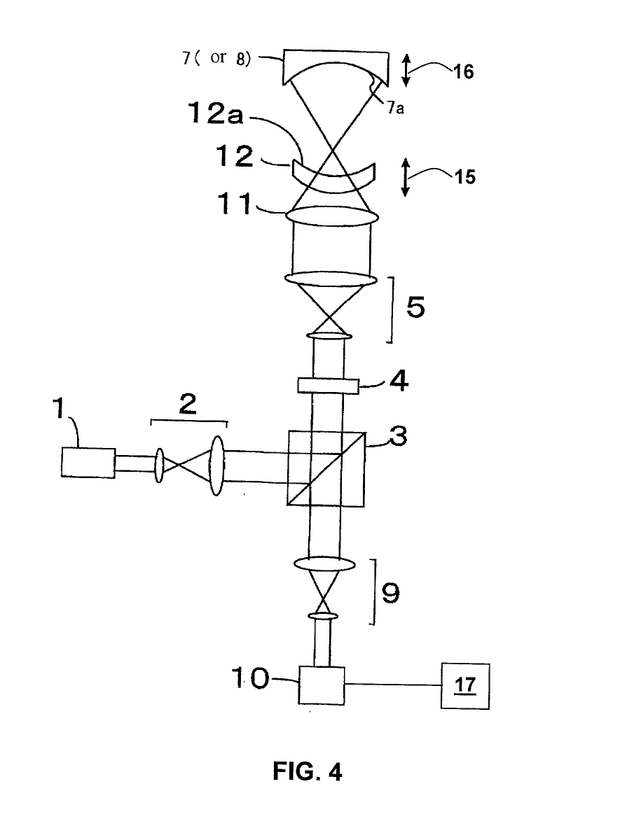

A surface-profile measurement apparatus according to this embodiment is depicted in FIG. 4. In FIG. 4, components that are the same as respective components shown in FIG. 1 have the same respective reference numbers and are not described further.

In this embodiment, the Fizeau lens 6 of the first representative embodiment (FIG. 1) is separated into a Fizeau element 12 having a Fizeau surface 12a and a lens component 11 providing the remaining aspects of the Fizeau lens 6. Other portions of the apparatus of FIG. 4 are the same as in the apparatus of FIG. 1.

Whenever there is a reflection-noise source present within the Fizeau lens 6 of FIG. 1, the effect of the noise light cannot be reduced because the phase of the noise light changes with corresponding changes in the phase of the reference-light flux. However, this problem is solved in this second representative embodiment by separating the Fizeau lens 6 into a Fizeau member 12 (providing a Fizeau surface 12a) and the lens component 11.

In measuring a target surface using an apparatus according to this embodiment, as in using the apparatus of the first representative embodiment, a phase-shift-interference method is used. Phase modulation of the measurement-light flux can be determined at various phase steps (e.g., 0→π/2→π→3π/2), wherein the phases of both the Fizeau member 12 (producing the reference-light flux) and the target object 7 (producing the measurement-light flux) are stepped over the range 0→π/2→π→3π/2 with respect to the standard (initial phase “0”). Alternatively, a phase-shift-interference method featuring the phase modulation of the reference-light flux may be used. Further alternatively, a phase-shift-interference method featuring the phase modulation of the measurement-light flux at the steps 0→π/2→π→3π/2 can be used in which the phase of the Fizeau element (producing the reference-light flux) is stepped with respect to a standard (“0” initial phase) over the range 0→π→3π/2. Further alternatively, a phase-shift-interference method can be used featuring the phase modulation of the Fizeau element at the steps 0→π/2→π→3π/2, wherein the phase of the target object (producing the measurement-light flux) is stepped with respect to the standard (initial phase).

Third Representative Embodiment

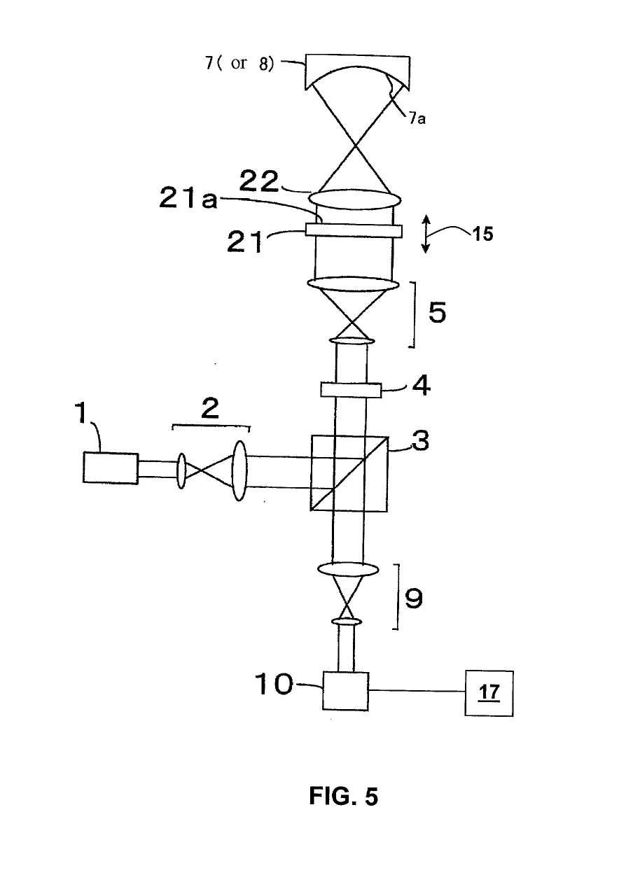

A surface-profile measurement apparatus according to this embodiment is depicted in FIG. 5. In FIG. 5, components that are the same as respective components shown in FIG. 1 have the same respective reference numbers and are not described further.

In this embodiment, the Fizeau lens 6 of the first representative embodiment (FIG. 1) is replaced with a planar Fizeau element 21 (having a Fizeau surface 21a) and a null lens 22. Other portions of the apparatus of FIG. 5 are the same as in the apparatus of FIG. 1.

Of the polarized light transmitted by the second beam-expander 5, the polarized light reflected by the Fizeau surface 21a is used as the reference-light flux. The polarized light transmitted by the Fizeau surface 21a is used as the measurement-light flux.

The null lens 22 is configured so that the measurement-light wavefront incident thereto is converted into a wavefront that is incident, in the same phase, perpendicularly to the target surface 7a of the target object 7 or a surface of the standard prototype 8. Specifically, the null lens 22 converts the incident wavefront into a wavefront having the same profile as the target surface 7a.

During measurements, the planar Fizeau element 21 is moved in the optical-axis direction (arrow 15) and the phase is stepped with respect to a standard (0→π/2→π3π/2). The phase difference between the measurement-light flux and the reference-light flux at each step is measured by phase modulation (0→π/2→π→3π/2) of the measurement-light flux.

To cause phase modulation of the measurement-light flux, the target surface 7a of the target object 7 (or the surface of the standard prototype 8) can be displaced minutely by a piezoelectric element (not shown).

The measurement procedure and the principle behind reducing noise in this embodiment are the same as described above in the first representative embodiment.

In this embodiment, phase stepping is achieved by moving a planar Fizeau element. If the target object 7 (or standard prototype 8) is at the π/2 phase step, then a phase-shift interference method can be employed in which phase modulation is achieved by moving the planar Fizeau element 21.

In this embodiment as shown, the null element was a lens. Alternatively, the null element can be a diffraction optical element (such as a zone plate).

Fourth Representative Embodiment

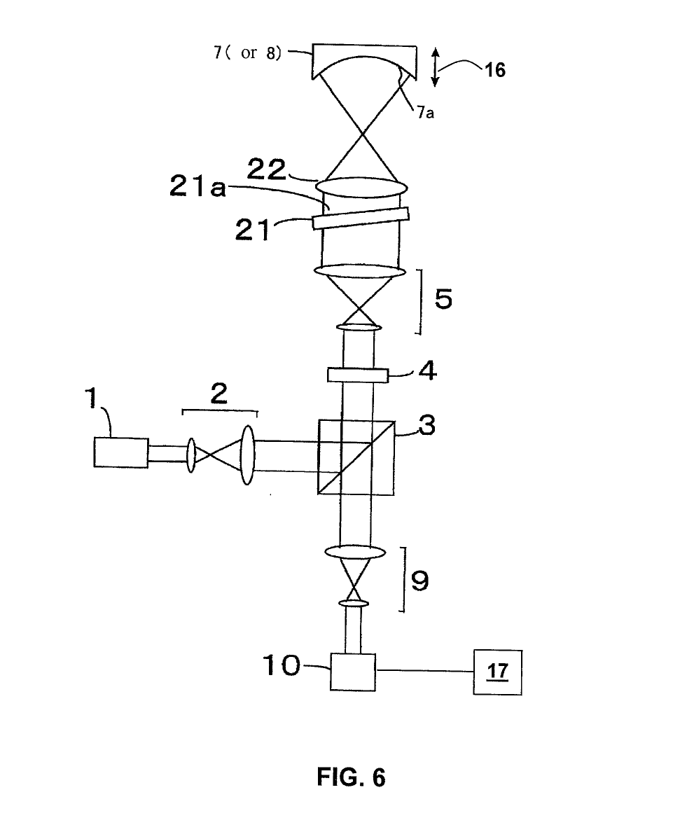

A surface-profile measurement apparatus according to this embodiment is depicted in FIG. 6. In FIG. 6, components that are the same as respective components shown in FIG. 1 have the same respective reference numbers and are not described further.

In this embodiment, the planar Fizeau element 21 of the third representative embodiment (FIG. 5) is disposed at a specific angle (other than perpendicular) to the optical axis. Other portions of the apparatus of FIG. 6 are the same as in the apparatus of FIG. 5. By disposing the planar Fizeau element 21 at an angle to the optical axis, the phase distribution of interference fringes of the measurement-light flux and of the reference-light flux includes a sine-wave frequency distribution. The sine-wave frequency distribution corresponds to the tilt angle (i.e., the angle between a plane perpendicular to the optical axis and the planar Fizeau element 21). This phase distribution of the interference fringes is the result of spatial phase modulation of the phase distribution of the interference fringes relative to a situation in which there is no tilt to the planar Fizeau element 21. This phase distribution can be detected in the same way as with a phase-shift-interference method.

The target surface 7a of the target object (or standard prototype 8) is moved in the optical-axis direction. The phase of the measurement-light flux is stepped with respect to the standard.

In this embodiment, the measurement procedure and the principle behind reducing noise are the same as described in the first representative embodiment.

Fifth Representative Embodiment

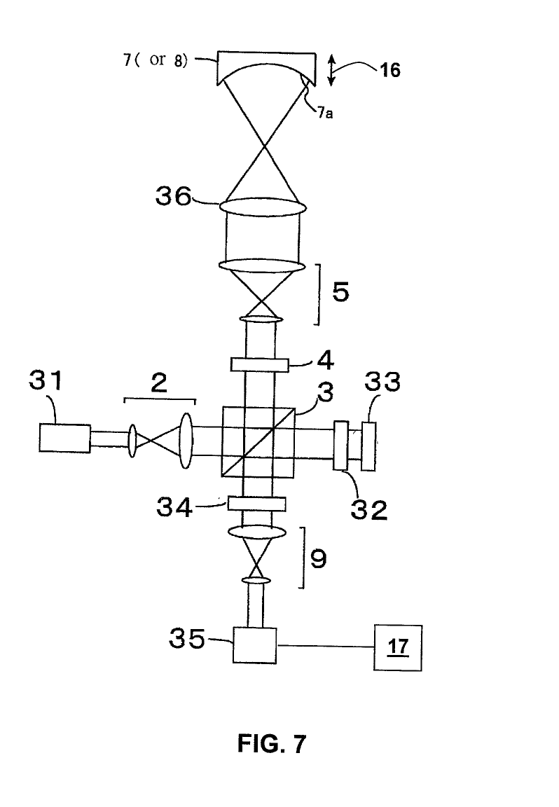

A surface-profile measurement apparatus according to this embodiment is depicted in FIG. 7. In FIG. 7, components that are the same as respective components shown in FIG. 1 have the same respective reference numbers and are not described further. In FIG. 7, item 31 is a dual-frequency laser, item 32 is a λ/4 retarder, item 33 is a planar reflecting mirror, item 34 is a polarizing filter, item 35 is a two-dimensional detector, and item 36 is a lens.

A light flux from the dual-frequency laser 31 has a perpendicular polarization plane, and the frequencies are slightly different from each other in a manner as used in heterodyne interferometer systems. The light flux from the laser 31 is incident on the PBS 3 via the first beam expander 2. Light of one frequency and having a polarization plane that is reflected by the PBS 3 is used as the measurement-light flux, whereas light of the other frequency and having a polarization plane that is transmitted by the PBS 3 is used as the reference-light flux.

The reference-light flux passes through the λ/4 retarder 32 and is reflected by the mirror 33. The reflected light then returns through the λ/4 retarder 32, is reflected by the PBS 3, passes through the polarizing filter 34 and the beam-reducer 9, and is incident on the two-dimensional detector 35.

Meanwhile, the measurement-light flux passes through the λ/4 retarder 4, the second beam-expander 5, and the lens 36, and is incident on the target surface 7a of the target object 7. Measurement light reflected from the target surface 7a returns via the same optical path as its forward path. The light then is transmitted by the PBS 3, passes through the polarizing filter 34 and the beam-reducer 9, and is incident on the two-dimensional detector 35.

Interposing the polarizing filter 34 in the manner shown in FIG. 7 produces heterodyne interference fringes for both the measurement-light flux and the reference-light flux. The phase difference between the measurement-light flux and the reference-light flux can be detected by analyzing these heterodyne interference fringes.

The position of the target surface 7a of the target object 7 in the optical-axis direction is moved (arrow 16) and the phase of the measurement-light flux is stepped, as described above, with respect to the standard. The phase difference between the measurement-light flux and the reference-light flux is detected at each step, and the average thereof calculated. The results of these calculations reflect the reduction of reflection noise from the beam expander 5 and the lens 36, as achieved using this embodiment.

Using the apparatus of FIG. 7, the same measurement method described above is performed for the standard prototype 8 instead of the target object 7, yielding the phase distribution of the interference fringes of the standard prototype 8. The phase differences, at various points on the target surface 7a versus respective points on the standard prototype 8, are calculated to yield data regarding the profile of the target surface versus the standard prototype. The differences in phase distributions are calculated by the computer 17.

Using any of the first through fifth representative embodiments, the respective surface profiles (including planar profiles) of optical elements destined for use in a projection-lens system can be measured with high accuracy and precision. Any optical elements that do not meet specifications can be re-polished and measured again before being incorporated into a projection-lens system or other optical system.

Sixth Representative Embodiment

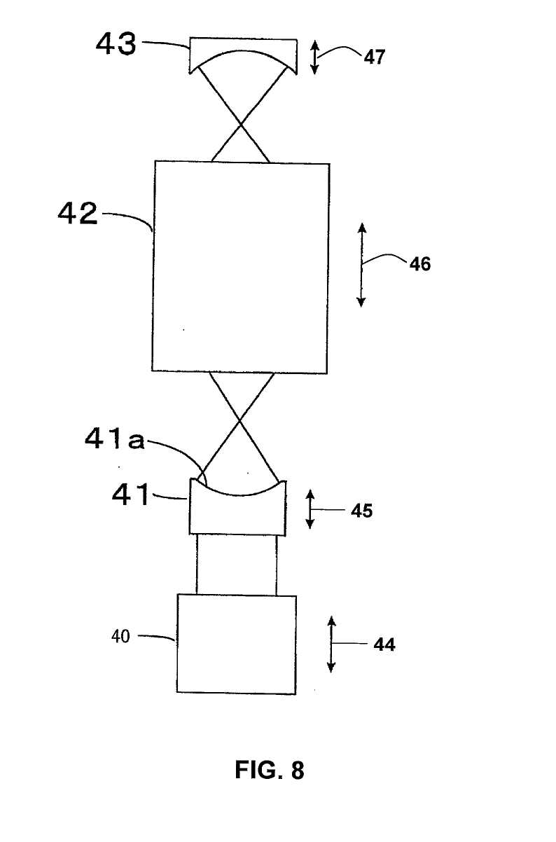

An apparatus, according to this embodiment, for measuring wavefront aberrations is depicted in FIG. 8. In the figure, item 40 is an interferometer system, item 41 is a Fizeau lens (including a Fizeau surface 41a), item 42 is a projection-lens system, and item 43 is a return spherical mirror. The interferometer system 40 corresponds to the structure, in any of the first through fifth representative embodiments, from the laser-light source to just upstream of the Fizeau lens 41 (null lens or planar Fizeau element).

In FIG. 8, polarized light from the interferometer system 40 is incident on the Fizeau lens 41. Light reflected from the Fizeau surface 41a is used as the reference-light flux, and light transmitted by the Fizeau surface 41a is used as the measurement-light flux. The measurement-light flux is transmitted by the projection-lens system 42 and reflected by the return spherical mirror 43; the reflected light returns along the same optical path as the forward path.

The spherical center of the Fizeau surface 41a and the spherical center of the return spherical mirror 43 are in an object-image, respectively, relationship to the projection-lens system 42. I.e., the spherical center of the Fizeau surface 41a is at an object position, and the spherical center of the return spherical mirror 43 is at an image position of the projection-lens system 42. Thus, the spherical center of the Fizeau surface 41a and the spherical center of the return spherical mirror 43 are in a conjugate positional relationship relative to the projection-lens system 42.

In this embodiment, the method for analyzing interference fringes of the measurement-light flux and the reference-light flux is the same as performed using an interferometer for measuring surface profile. The wavelength of the light source used with the apparatus for measuring wavefront aberrations is preferably either the same as the wavelength of the light source used for the projection-lens system as mounted in a projection-exposure apparatus, or as close to that wavelength as possible.

Phase stepping can be accomplished by a method in which the interferometer system 40 is moved in the optical-axis direction (arrow 44). Alternatively, phase stepping can be accomplished by a method in which the return spherical mirror 43 (arrow 47), the projection-lens system 42 (arrow 46), and the Fizeau lens 41 (arrow 45) are moved equal distances in the optical-axis direction. In either method, suitable mechanisms are provided to achieve the requisite movements.

With a method, according to this embodiment, for measuring wavefront aberrations, the phase of the return spherical mirror 43, the projection-lens system 42, and the Fizeau lens 41 is stepped over the range 0 (initial phase)→π/2→π→3π/2 with respect to the standard. At each phase step, the phase difference produced by interference between the light (measurement-light flux) transmitted by the projection-lens system 42 and the light (reference-light flux) reflected from the Fizeau surface 41a is measured. An average is calculated for these four measurement values. During measurement of the phase difference at each phase step, a phase-shift-interference method featuring either the phase modulation of transmitted light (measurement-light flux) or reflected light (reference-light flux) is used.

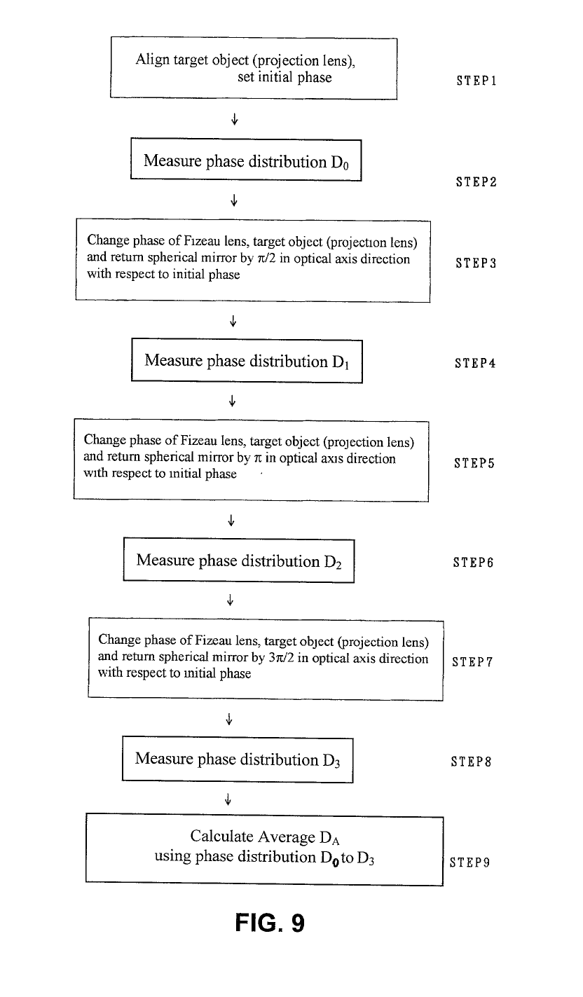

A procedure for operating the wavefront-aberration-measurement apparatus of FIG. 8 and for processing data produced by the apparatus as used for measuring the transmission wavefront of a target object is shown in FIG. 9. FIG. 9 is in the form of a flow chart.

In a first step (step 1), the target object (e.g., the projection-lens system 42) is mounted in a holder (not shown) of the wavefront-measurement apparatus. The target object 42 is aligned by being shifted or tilted in the X- and Y-axis directions or by being minutely moved in the Z-axis direction to produce interference fringes that are as coarse as possible. This initial state is termed the “standard” (“initial phase”) of the reference-light flux and measurement-light flux. At this phase step, the phase distribution D₀ of the transmission wavefront is measured for the target object 42 using the phase-shift-interference method as described above (Step 2).

Next, the return spherical mirror 43, the target object 42, and the Fizeau lens 41 are displaced in the optical-axis direction by a distance equivalent to the phase step π/2 with respect to the standard (Step 3). At this phase step, the phase distribution of the interference fringes is in substantially the same state as in the initial state (i.e., at the time of measuring D₀). Using the phase-shift-interference method, the phase distribution D₁ (the phase distribution of the transmission wavefront) is measured at the phase step π/2 with respect to the standard (Step 4).

Phase stepping, with respect to the standard, and measurement of the phase distribution of the interference fringes at the phase steps π and 3π/2 are repeated in the same way as described above to obtain the phase distributions D₂ and D₃ (Steps 5-8).

Next, the phase distributions D₀, D₁, D₂, and D₃ obtained above are used to calculate an average phase distribution D_{A}. The average distribution D_{A} is input to a computer algorithm for calculating specific transmission wavefront errors as a phase distribution of the interference fringes between the measurement-light flux and the reference-light flux (Step 9). The reason for averaging multiple phase distributions is to reduce the effect of noise light, as mentioned above, according to the principles discussed above.

In an alternative method for measuring wavefront aberration the phase of the return spherical mirror 43 and the projection-lens system 42 is stepped with respect to the standard (initial phase) as follows: 0 (initial phase)→π/2→π→3π/2. At each step, the phase difference resulting from interference between the light transmitted by the projection-lens system 42 (measurement-light flux) and the light reflected from the Fizeau surface 41 a (reference-light flux) is calculated. From these four measured phase differences, an average is calculated.

In another alternative method, the phase of the Fizeau surface 41a of the Fizeau lens 41 is stepped with respect to the standard over the range: 0 (initial phase)→π/2→π→3π/2. At each step, the phase difference resulting from interference between the light transmitted by the projection-lens system 42 (measurement-light flux) and the light reflected from the Fizeau surface 41a (reference-light flux) is calculated. From these four measured phase differences, an average is calculated.

Whenever reflected light within a projection-lens system 42 becomes noise light, phase stepping may be performed by moving the return spherical mirror 43 and the Fizeau lens 41 so as to satisfy a conjugate relationship of these components relative to the projection-lens system 42. In this instance, if the return spherical mirror 43 is at the π/2 phase step relative to the projection-lens system 42, then a phase-shift-interference method can be employed in which the Fizeau lens 41 is moved in the optical-axis direction. If the Fizeau lens 41 is at the π/2 phase step, then a phase-shift-interference method can be employed in which the return spherical mirror 43 is moved in the optical-axis direction.

In measurements performed using a surface-profile-measurement apparatus according to any of the first through fifth representative embodiments or the wavefront-aberration-measurement apparatus according to the sixth representative embodiment, the phase change with respect to the standard (initial phase) was according to the sequence: 0→π/2→π→3π/2. Alternatively, the phase steps can be smaller, such as: 0→π/4→π/2→3π/4→π→5π/4→3π/2→7π/4. Also, averages can be calculated from data obtained by randomly selecting phase steps.

A projection-lens system for a projection-exposure apparatus is manufactured by incorporating the optical elements having a specified planar accuracy, determined as described above, into the optical tube. Wavefront aberrations of the projection-lens system can be measured using the wavefront aberration-measurement apparatus of the sixth representative embodiment. If the projection-lens system does not exhibit a wavefront aberration within specifications, then assembly and adjustment of the system are repeated as required, followed by a re-measurement of the wavefront aberration. This process is repeated until the projection-lens system meets specifications.

Whereas the invention has been described above in the context of multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. An apparatus for measuring a surface profile of a target surface, comprising:
a light source configured to produce a light flux;
a light-flux optical system situated relative to the light source and the target surface and configured to (i) produce from the light flux a measurement-light flux and a reference-light flux, (ii) direct the measurement-light flux to the target surface so as to reflect from the target surface, (iii) provide the reference-light flux with a standard wavefront, and (iv) establish an interference between the reference-light flux and the measurement-light flux reflected from the target surface;
a phase-state changing device situated and configured to change a phase state of at least one of the reference-light flux and measurement-light flux relative to a standard;
a detector situated and configured to detect interference fringes produced by the interference at any of the various phase states; and
a computer connected to the detector and to the phase-state changing device, the computer being configured to produce, from the detected interference fringes produced at different respective phase states, data concerning respective phase distributions, and to calculate an average phase distribution.

2. The apparatus of claim 1, wherein the phase-state changing device is configured to change the phase state of the reference-light flux.

3. The apparatus of claim 1, wherein the phase-state changing device is configured to change the phase state of the measurement-light flux.

4. The apparatus of claim 1, wherein the phase-state changing device is configured to change the phase state of both the reference-light flux and the measurement-light flux a same amount relative to the standard, while maintaining a constant phase difference between the reference-light flux and the measurement-light flux.

5. The apparatus of claim 1, further comprising a phase-modulation device situated and configured to produce a phase modulation of the measurement-light flux.

6. The apparatus of claim 1, further comprising a phase-modulation device situated and configured to produce a phase modulation of the reference-light flux.

7. The apparatus of claim 1, wherein:
the measurement-light flux has a frequency that is slightly different than a frequency of the reference-light flux; and
the interference is heterodyne interference.

8. The apparatus of claim 1, wherein the phase-state changing device is configured to change the phase state in respective increments, relative to the standard, of 0, π/2, π and 3π/2.

9. The apparatus of claim 1, wherein the phase-state changing device is configured to change the phase state in respective increments, relative to the standard, of 0, π/4, π/2, 3π/4, π, 5π/4, 3π/2, and 7π/4.

10. The apparatus of claim 1, wherein the phase-state changing device is configured to change the phase state in respective irregular increments, relative to the standard, of from 0 to 2π and more than 2π as a whole.

11. An apparatus for measuring a wavefront aberration of a target object, comprising:
a light source configured to produce a light flux;
a light-flux optical system situated relative to the light source and the target object and configured to (i) produce from the light flux a measurement-light flux and a reference-light flux, (ii) direct the measurement-light flux to the target object so as to be transmitted through the target object, (iii) provide the reference-light flux with a standard wavefront, and (iv) establish an interference between the reference-light flux and the measurement-light flux transmitted by the target object;
a phase-state changing device situated and configured to change a phase state of at least one of the reference-light flux and measurement-light flux relative to a standard;
a detector situated and configured to detect interference fringes produced by the interference at any of the various phase states; and
a computer connected to the detector and the phase-state changing device, the computer being configured to produce, from the detected interference fringes produced at different respective phase states, data concerning respective phase distributions, and to calculate an average phase distribution.

12. The apparatus of claim 11, wherein the phase-state changing device is configured to change the phase state of the reference-light flux.

13. The apparatus of claim 11, wherein the phase-state changing device is configured to change the phase state of the measurement-light flux.

14. The apparatus of claim 11, wherein the phase-state changing device is configured to change the phase state of both the reference-light flux and the measurement-light flux a same amount relative to the standard, while maintaining a constant phase difference between the reference-light flux and the measurement-light flux.

15. The apparatus of claim 11, further comprising a phase-modulation device situated and configured to produce a phase modulation of the measurement-light flux.

16. The apparatus of claim 11, further comprising a phase-modulation device situated and configured to produce a phase modulation of the reference-light flux.

17. The apparatus of claim 11, wherein:
the measurement-light flux has a frequency that is slightly different than a frequency of the reference-light flux; and
the interference is heterodyne interference.

18. The apparatus of claim 11, wherein the phase-state changing device is configured to change the phase state in respective increments, relative to the standard, of 0, π/2, π, and 3π/2.

19. The apparatus of claim 11, wherein the phase-state changing device is configured to change the phase state in respective increments, relative to the standard, of 0, π/4, π/2, 3π/4, π, 5π/4, 3π/2, and 7π/4.

20. The apparatus of claim 11, wherein the phase-state changing device is configured to change the phase state in respective irregular increments, relative to the standard, of from 0 to 2π and more than 2π as a whole.

21. A method for measuring a surface profile of a target surface of an object, comprising the steps:
(a) directing a measurement-light flux to the target surface so as to cause the measurement-light flux to reflect from the target surface;
(b) providing a reference-light flux having a standard wavefront produced by reflection from a standard surface;
(c) establishing a mutual interference between the reference-light flux and the measurement-light flux;
(d) detecting a respective phase-difference interference pattern produced by the interference;
(e) moving at least one of the target surface and the standard surface a respective specified distance from a respective standard position and then repeating steps (a)-(d), the respective specified distance being appropriate to change a phase state of the at least one of the light fluxes a specified amount;
(f) repeating step (e) to obtain respective phase-difference interference patterns at multiple phase states; and
(g) determining an average phase-difference distribution of the target surface from the respective phase-difference interference patterns obtained at the multiple phase states.

22. The method of claim 21, wherein step (e) comprises moving the standard surface.

23. The method of claim 21, wherein step (e) comprises moving the target surface.

24. The method of claim 21, wherein step (e) comprises moving both the target surface and the standard surface while maintaining a constant phase difference between the reference-light flux and the measurement-light flux.

25. The method of claim 21, wherein:
step (e) comprises moving the standard surface; and
step (d) is performed by phase-shift interference involving phase modulation of the measurement-light flux.

26. The method of claim 21, wherein;
step (e) comprises moving the target surface; and
step (d) is performed by phase-shift interference involving phase modulation of the reference-light flux.

27. The method of claim 21, further comprising the step of providing the measurement-light flux with a frequency that is slightly different than a frequency of the reference-light flux so as to establish, in step (c), a heterodyne interference between the reference-light flux and the measurement-light flux.

28. The method of claim 21, wherein, in step (e), the at least one of the target surface and the standard surface is moved so as to change the phase state in a respective increment, relative to the standard, of 0, π/2, π, and 3π/2.

29. The method of claim 21, wherein, in step (e), the at least one of the target surface and the standard surface is moved so as to change the phase state in a respective increment, relative to the standard, of 0, π/4, π/2, 3π/4, π, 5π/4, 3π/2, and 7π/4.

30. The method of claim 21, wherein, in step (e), the at least one of the target surface and the standard surface is moved so as to change the phase state by one or more irregular increments, relative to the standard, of from 0 to 2π and more than 2π as a whole.

31. The method of claim 21, wherein the object is an optical element.

32. An optical element, comprising a target surface having a surface profile measured using the method of claim 21.

33. A method for measuring a wavefront aberration of a target object, comprising the steps:
(a) directing a measurement-light flux to the target object so as to cause the measurement-light flux to be transmitted in a first direction through the target object to a reflection member;
(b) reflecting the measurement-light flux, that has been transmitted in a first direction through the target object, so as to cause the measurement-light flux to return through the target object in a second direction;
(c) providing a reference-light flux having a standard wavefront produced by reflection from a standard surface;
(d) establishing a mutual interference between the reference-light flux and the returning measurement-light flux;
(e) detecting a respective phase-difference interference pattern produced by the interference;
(f) moving at least one of (i) the reflection member and (ii) the standard surface a respective specified distance from a respective standard position and then repeating steps (a)-(e), the respective specified distance being appropriate to change a phase state of the at least one of the light fluxes a specified amount;
(g) repeating step (f) to obtain respective phase-difference interference patterns at multiple phase states; and
(h) determining an average phase-difference distribution of the target object from the respective phase-difference interference patterns obtained at the multiple phase states.

34. The method of claim 33, wherein step (b) comprises providing a mirror downstream of the target object so as to reflect the measurement light flux.

35. The method of claim 33, wherein step (f) comprises moving both the target object with reflection member and the standard surface while maintaining a constant phase difference between the reference-light flux and the measurement-light flux.

36. The method of claim 33, wherein:
step (e) further comprises modulating the measurement-light flux; and
in step (d) the detected interference is a phase-shift interference.

37. The method of claim 33, wherein;
step (e) further comprises modulating the reference-light flux; and
in step (d) the detected interference is a phase-shift interference.

38. The method of claim 33, further comprising the step of providing the measurement-light flux with a frequency that is slightly different than a frequency of the reference-light flux so as to establish, in step (a), a heterodyne interference between the reference-light flux and the measurement-light flux.

39. The method of claim 33, wherein, in step (f), the at least one of the reflection member and the standard surface is moved so as to change the phase state in a respective increment, relative to the standard, of 0, π/2, π, and 3π/2.

40. The method of claim 33, wherein, in step (f), the at least one of the reflection member and the standard surface is moved so as to change the phase state in a respective increment, relative to the standard, of 0, π/4, π/2, 3π/4, π, 5π/4, 3π/2, and 7π/4.

41. The method of claim 33, wherein, in step (f), the at least one of the reflection member and the standard surface is moved so as to change the phase state by one or more irregular increments, relative to the standard, of from 0 to 2π and more than 2π as a whole.

42. The method of claim 33, wherein the target object is a lens element.

43. A lens element, of which the wavefront aberration has been measured using the method of claim 33.

44. A projection lens system, comprising the lens element of claim 43.

45. A projection lens system, of which the wavefront aberration has been measured using the method of claim 33.

46. An apparatus for measuring an optical characteristic of a target object, comprising:
a light source configured to produce a light flux;
a light detector;
an optical system situated relative to the light source and the target object and configured to (i) produce from the light flux a measurement-light flux and a reference-light flux, (ii) direct the measurement-light flux to the target object so as to reflect from a target surface of the target object, (iii) provide the reference-light flux with a standard wavefront, (iv) establish an interference between the reference-light flux and the measurement-light flux from the target object; and (v) direct the interfering reference-light flux and measurement-light flux to the detector;
an actuator situated and configured to move at least one of the target object and the standard surface a respective specified distance relative to a respective standard location;
a phase-detection device connected to the detector and configured to detect respective phase differences in the detected light, at the various locations resulting from movement, achieved by the actuator, of the at least one of the target object and the standard surface over the respective specified distance; and
a computer configured to determine respective phase distributions from the respective phase differences and to calculate, from the respective phase distributions, an average phase distribution, the average phase distribution corresponding to a measurement of the optical characteristic.

47. The apparatus of claim 46, wherein the optical characteristic is a surface profile of the target object.

48. The apparatus of claim 46, wherein the actuator is configured to move the target object relative to the respective standard location.

49. The apparatus of claim 46, wherein the actuator is configured to move the standard surface relative to the respective standard location.

50. The apparatus of claim 46, wherein the actuator is configured to move both the standard surface and the target object relative to the respective standard locations while maintaining a constant phase difference in the interfering reference-light flux and measurement-light flux.

51. An apparatus for measuring an optical characteristic of a target object, comprising:
a light source configured to produce a light flux;
a light detector;
an optical system situated relative to the light source and the target object and configured to (i) produce from the light flux a measurement-light flux and a reference-light flux, (ii) direct the measurement-light flux to the target object so as to pass through the target object, (iii) provide the reference-light flux with a standard wavefront, (iv) establish an interference between the reference-light flux and the measurement-light flux from the target object; and (v) direct the interfering reference-light flux and measurement-light flux to the detector;
a reflection member situated relative to the target object such that measurement light transmitted in a first direction through the target object reflects from the reflection member and returns via a second direction, opposite the first direction, through the target object to interfere with the reference-light flux;
an actuator situated and configured to move at least one of the target object and the reflection member, and the standard surface, a respective specified distance relative to a respective standard location;
a phase-detection device connected to the detector and configured to detect respective phase differences in the detected light, at the various locations resulting from movement, achieved by the actuator, of the at least one of the target object and the reflection member, and the standard surface, over the respective specified distance; and
a computer configured to determine respective phase distributions from the respective phase differences and to calculate, from the respective phase distributions, an average phase distribution, the average phase distribution corresponding to a measurement of the optical characteristic.

52. The apparatus of claim 51, wherein the optical characteristic is a wavefront aberration of the target object.

53. The apparatus of claim 51, wherein the actuator is configured to move the target object, the reflection member, and the standard surface while maintaining a constant distance between the target object, the reflection member, and the standard surface.

54. The apparatus of claim 51, wherein the actuator is configured to move both the target object and the reflection member while maintaining a constant distance between the target object and the reflection member.

55. The apparatus of claim 51, wherein the actuator is configured to move the standard surface.

56. The apparatus of claim 46, wherein the target object is a lens element.

57. A lens element, of which the optical characteristic is a surface profile measured using an apparatus as recited in claim 46.

58. A projection lens system, comprising the lens element of claim 57.

59. A projection lens system, of which the optical characteristic is a surface profile measured using an apparatus as recited in claim 46.

60. The apparatus of claim 51, wherein the target object is a lens element.

61. A lens element, of which the optical characteristic is a wavefront aberration measured using an apparatus as recited in claim 51.

62. A projection lens system, comprising the lens element of claim 61.

63. A projection lens system, of which the optical characteristic is a wavefront aberration measured using an apparatus as recited in claim 51.
